(19) United States
(12) Patent Application Publication
(10) Pub. No.: US 2017/0123478 A1
(43) Pub. Date: May 4, 2017

(54) METHOD FOR MANAGING DEVICES BASED ON ENTRANCE GUARD INFORMATION AND SWITCH

(71) Applicant: Wistron NeWeb Corp., Hsinchu (TW)

(72) Inventor: Sheng-Kun Shen, Hsinchu (TW)

(21) Appl. No.: 15/137,009

(22) Filed: Apr. 25, 2016

(30) Foreign Application Priority Data
Oct. 28, 2015 (TW) 104135365

(51) Int. Cl. G06F 1/32; G06F 1/26; H04B 3/54

(52) U.S. Cl. CPC G06F 1/3234; H04B 3/54; G06F 1/266

(57) ABSTRACT

A method for managing devices based on entrance guard information and a switch are proposed. The method of the disclosure records electronic devices of a specific user in a network management table. When the specific user logs out an entrance guard system, the method of the disclosure disables at least one function of the electronic devices of the specific user.

### CROSS-REFERENCE TO RELATED APPLICATION

This application claims the priority benefit of Taiwan application serial no. 104135365, filed on Oct. 28, 2015. The entirety of the above-mentioned patent application is hereby incorporated by reference herein and made a part of this specification.

### BACKGROUND OF THE INVENTION

Field of the Invention

The invention relates to a method for managing devices based on entrance guard information and a switch.

Description of Related Art

Along with the widespread of environmental protection awareness, the concept of energy saving and carbon reduction gradually draws attention of the public. In order to avoid excess power consumption, many companies advocate their employees to turn off computers or other electrical appliances that are no longer used after the work when they go off duty. In order to make every employee to remember such concept, it is bound to spend a lot of effort. However, the employees still probably forget to turn off the computers when they go off duty, which causes a waste of power. In addition, there is one situation that someone may use the electronic devices owned by the user who has already gone off duty.

### SUMMARY OF THE INVENTION

The invention is directed to a method for managing devices based on entrance guard information and a switch. According to a user logged out an entrance guard system, a function of an electronic device corresponding to the user is opportunely turned off.

The invention provides a method for managing devices based on entrance guard information, which includes following steps. It is determined whether a user has logged out an entrance guard system, where the entrance guard system is coupled to a switch. When the user has logged out the entrance guard system, a status corresponding to the user is modified to an inactive status in a first network management table maintained by the switch. A function of the electronic device corresponding to the user in the first network management table is disabled.

The invention provides a switch coupled to an entrance guard system, which includes a memory device and a processor. The memory device stores a plurality of modules. The processor is coupled to the memory device, and accesses and executes the modules. The modules include a determining module, a modifying module and a disabling module. The determining module determines whether a user has logged out the entrance guard system. If the user has logged out the entrance guard system, the modifying module modifies a status corresponding to the user to an inactive status in a first network management table maintained by the switch. The disabling module disables a function of an electronic device corresponding to the user in the first network management table.

According to the above description, the method for managing devices based on entrance guard information and the switch provided by the present embodiment may record the users in the inactive status through the first network management table, and correspondingly disable the functions of the electronic devices corresponding to the users.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a switch according to an embodiment of the invention.

FIG. 2 is a flowchart illustrating a method for managing devices based on entrance guard information according to an embodiment of the invention.

FIG. 3 illustrates a system for managing devices based on entrance guard information according to an embodiment of the invention.

FIG. 4 is a system for managing devices based on entrance guard information according to an embodiment of the invention.

FIG. 5 is a system for managing devices based on entrance guard information illustrated according to FIG. 3 and FIG. 4.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

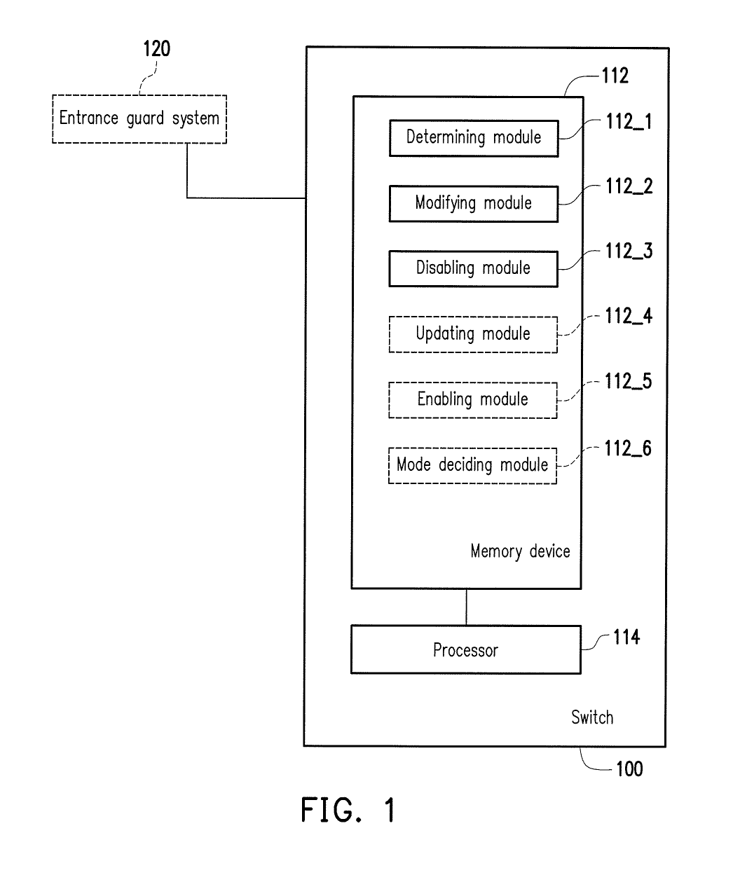

FIG. 1 is a functional block diagram of a switch according to an embodiment of the invention. In the present embodiment, the switch 100 is, for example, an Ethernet switch, though the invention is not limited thereto. The switch 100 includes a memory device 112 and a processor 114. The memory device 112 is, for example, a memory, a hard disk drive, or any other device capable of storing data, and stores a plurality of modules. The processor 114 is coupled to the memory device 112. The processor 114 is, for example, a general purpose processor, a plurality of microprocessors, one or a plurality of microprocessors combined with a digital signal processor core, a controller, a micro controller, an application specific integrated circuit (ASIC), a field programmable gate array (FPGA), any other type of IC, state machine, advanced RISC machine (ARM)-based processor and similar product.

In the present embodiment, the switch 100 can be coupled to an entrance guard system 120 to obtain entrance guard information of the entrance guard system 120. The entrance guard information is, for example, a status of each user logged in/out the entrance guard system 120 that is managed by the entrance guard system 120. For simplicity's sake, it is assumed that the entrance guard system 120 is disposed in a certain company, and is configured to manage attendance statuses of the staff of the company, though the invention is not limited thereto. In a different embodiment, the entrance guard system 120 is, for example, a radio frequency identification (RFID) device, a fingerprint identification device, an iris identification device, or other similar identification device suitable for the users to log in/out the entrance guard system 120 when the users are on/off duty. The users are, for example, staff of the company, though the invention is not limited thereto.

In the present embodiment, the processor 114 may access a determining module 112_1, a modifying module 112_2 and a disabling module 112_3 in the memory device to execute a method for managing devices based on entrance guard information of the invention.

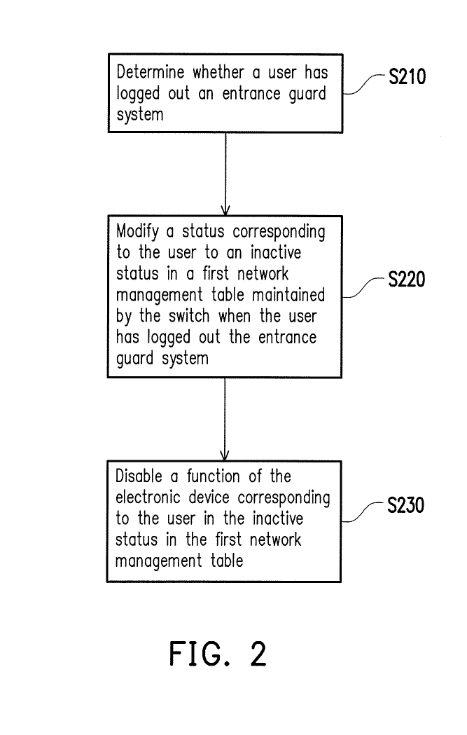

FIG. 2 is a flowchart illustrating a method for managing devices based on entrance guard information according to an embodiment of the invention. The method of the present embodiment can be executed by the switch 100 of FIG. 1, and detailed steps of the method are described below with reference of various components of FIG. 1.

In step S210, the determining module 112_1 determines whether the user has logged out the entrance guard system 120. In an embodiment, when the entrance guard system 120 determines that the user logs out the entrance guard system 120 at a predetermined non-duty time (for example, to punch out), the entrance guard system 120 may actively send a notification message to notify the switch 100. In another embodiment, the switch 100 may also continually, periodically or non-periodically monitor whether the user has logged out the entrance guard system 120, though the implementation of the invention is not limited thereto.

Then, in step S220, if the user has logged out the entrance guard system 120, the modifying module 112_2 modifies a status corresponding to the user to an inactive status in a first network management table maintained by the switch 100. Then, in step S230, the disabling module 112_3 disables a function of an electronic device corresponding to the user in the inactive status in the first network management table.

In the present embodiment, the first network management table is, for example, used for recording identities of the users and information such as active/inactive statuses of the users. Moreover, in a different embodiment, the first network management table can be designed into different patterns according to the functions of the electronic devices that can be disabled by the disabling module 112_3.

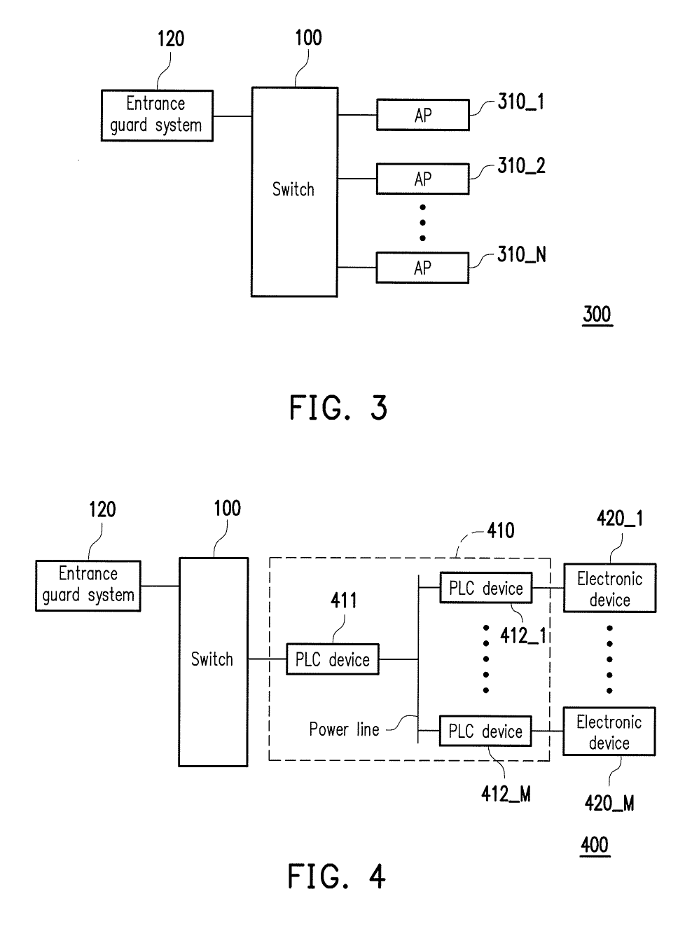

Referring to FIG. 3, FIG. 3 illustrates a system for managing devices based on entrance guard information according to an embodiment of the invention. In the present embodiment, the system 300 includes a switch 100, an entrance guard system 120 and access points (APs) 310_1-310_N (N is a positive integer) managed by the switch 100. The APs 310_1-310_N are, for example, built in the aforementioned company, and provide a wireless network for the staff of the company to access.

In the present embodiment, the disabling module 112_3 may disable a network access authority of the electronic device, for example, disable a medium access control (MAC) address corresponding to the electronic device, i.e. disable the network access authority of the electronic device. In other words, the disabling module 112_3 may set at least one MAC address in the first network management table to a disable status. In this case, the first network management table can be designed to a pattern of a following table 1.

TABLE 1

| User | | Ethernet MAC | Wireless network MAC | Wireless network MAC |
|---|---|---|---|---|
| identity | Status | address | address | address |
| 001 | Active | C4-54-44-79-41-AA | C4-54-44-79-41-1A | C4-54-44-79-41-1A |
| | status | Enable | Enable | Enable |
| 002 | Inactive | C4-54-44-79-41-AB | C4-54-44-79-41-1B | C4-54-44-79-41-1B |
| | status | Disable | Disable | Disable |
| 003 | Active | C4-54-44-79-41-AC | C4-54-44-79-41-1C | C4-54-44-79-41-1C |
| | status | Enable | Enable | Enable |
| 004 | Active | C4-54-44-79-41-AD | C4-54-44-79-41-1D | C4-54-44-79-41-1D |
| | status | Enable | Enable | Enable |
| 005 | Active | C4-54-44-79-41-AE | C4-54-44-79-41-1F | C4-54-44-79-41-1F |
| | status | Enable | Enable | Enable |
| . . . | . . . | . . . | . . . | . . . |

In the table 1, the user identity is, for example, an employee number of the user in the company or other identification information used for representing the user. The active/inactive status of the user represents a situation that the user logs in/out the entrance guard system 120. As shown in the table 1, when the user with the referential number of 002 is in the inactive status, the disabling module 112_3 may disable the MAC address of each of the electronic devices corresponding to the user in the table 1. In this way, the MAC address of each of the electronic devices corresponding to the user with the referential number of 002 is set to the disable status. Therefore, each of the electronic devices corresponding to the user with the referential number of 002 cannot access a wired/wireless network (for example, a wireless network provided by the APs 310_1-310_N) managed by the switch 100.

In an embodiment, the memory device 112 may further includes an updating module 112_4 configured to send the first network management table (for example, the table 1) to the APs 310_1-310_N to update a second network management table maintained by each of the APs 310_1-310_N after the modifying module 112_2 modifies the first network management table due to the log out of the user. The second network management table, for example, has the same format with that of the first network management table. In this way, after the user logs out the entrance guard system 120, the APs 310_1-310_N forbid the electronic devices of the user to access the wireless network through the disabled MAC addresses.

In an embodiment, when the determining module 112_1 determines that the user does not log out the entrance guard system 120, the modifying module 112_2 may modify the status corresponding to the user to the active status in the first network management table. In this case, the memory device 112 may enable at least one function of the electronic devices corresponding to the user in the first network management table through an enabling module 112_5, for example, to set the MAC addresses of the electronic devices corresponding to the user to an enable status, so as to enable the MAC addresses of the electronic devices. Moreover, the updating module 112_4 may also send the first network management table (for example, the table 1) to the APs 310_1-310_N to update a second network management table maintained by each of the APs 310_1-310_N. In this way, when the user does not log out the entrance guard system 120, the electronic devices corresponding to the user may access the network managed by the switch 100 through the enabled MAC addresses.

In another embodiment, the memory device 112 of the switch 100 may further include a mode deciding module 112_6. The mode deciding module 112_6 is configured to count the number of the users in the active status in the first network management table, and decides an operation mode of the APs 310_1-310_N according to the number of the users. For example, the mode deciding module 112_6 may determine whether the number of the users in the active status is higher than a first threshold (for example, 70% of the whole staff of the aforementioned company). If yes, the mode deciding module 112_6 may set the operation mode of the APs 310_1-310_N to a high performance mode; and if not, the mode deciding module 112_6 may determine whether the number of the users in the active status is between the first threshold and a second threshold (for example, 20% of the whole staff of the aforementioned company), i.e. between 20%-70%. If yes, the mode deciding module 112_6 may set the operation mode of the APs 310_1-310_N to an ordinary performance mode; and if not, the mode deciding module 112_6 may set the operation mode of the APs 310_1-310_N to a low performance mode.

In another embodiment, the user may log in the entrance guard system 120 through an electronic device having a network access function, for example, a smart phone, a tablet personal computer (PC), etc. In this case, the entrance guard system 120 may write a service set identifier and a password corresponding to the SSID into the electronic device having the network access function that is used for logging in the entrance guard system 120. According to the SSID and the corresponding password thereof, the user may access the wireless network provided by the APs managed by the switch 100. In other words, based on the SSID and the corresponding password thereof, the electronic device of the user having the network access function has a network access authority of the network managed by the switch 100. In this case, when the user logs out the entrance guard system 120, the disabling module 112_3 may disable the network access authority of the electronic device of the user by disabling the SSID and/or the corresponding password thereof.

In another embodiment, when the disabling module 112_3 has the authority to directly turn off the electronic devices of the user in the inactive status, the first network management table may present a pattern shown in a following table 2.

TABLE 2

| User ID | Status | Electronic device | |
|---|---|---|---|
| 006 | Inactive status | PC | Notebook |
| | | Disable | Disable |
| 007 | Active status | PC | |
| | | Enable | |

Under the pattern of the table 2, the disabling module 112_3 may turn off the PC and the notebook of the user with a referential number of 006 through remote shutdown or remote desktop shutdown, though the invention is not limited thereto.

Referring to FIG. 4, FIG. 4 is a system for managing devices based on entrance guard information according to an embodiment of the invention. In the present embodiment, the system 400 includes the switch 100, the entrance guard system 120 and a power line communication (PLC) network 410 managed by the switch 100. The PLC network 410 includes PLC devices 411, 412_1-412_M (M is a positive integer) connected to each other through a power line. The PLC network 410 can be built in the aforementioned company, and the staff of the company may access the PLC network 410 managed by the switch 100 through the electronic devices 420_1-420_M. The PLC devices 411, 412_1-412_M may respectively include an Ethernet port and an alternating current (AC) port. The Ethernet port and the AC port of the PLC device 411 can be respectively connected to the switch 100 and the power line. The Ethernet ports of the PLC devices 412_1-412_M can be respectively connected to the electronic devices 420 _1-420_M for providing power and a network access authority to the electronic devices 420_1-420_M. The AC ports of the PLC devices 412_1-412_M can be connected to the power line for communicating with the PLC device 411.

In the present embodiment, it is assumed that the electronic devices 420 _1-420 _M all correspond to a certain user in the inactive status. In this case, the disabling module 112_3 may control the PLC devices 412_1-412_M to stop providing the power to the electronic devices 420_1-420_M, to turn off the electronic devices 420 _1-420 _M or disable the network access authority of the electronic devices 420 _1-420 _M (for example, not to provide network signals to the electronic devices 420 _1-420 _M). Particularly, a difference between the operations of stopping providing the power to the electronic devices and turning off the electronic devices is that after providing of the power is stopped, the user cannot again activate the electronic devices, and after the power devices are turned off, the user may again activate the electronic devices.

In an embodiment, the disabling module 112_3 may firstly turn off the electronic devices 420_1-420_M and then disable the network access authority of the electronic devices 420_1-420_M. Moreover, when the disabling module 112_3 detects that any one of the turned off electronic devices 420_1-420_M (for example, the electronic device 420_1) tries to access the network provided by the switch 100, the disabling module 112_3 may again turn off the electronic device 420_1, and/or the switch 100 notifies the user of the electronic devices 420_1-420_M through a warning message (for example, an E-mail or a short message service (SMS) message) according to the user information corresponding to the MAC address. Namely, when the electronic device 420_1 in a turn-off state is activated by someone to access the network, the disabling module 112_3 may again turn off the electronic device 420_1. Alternatively, the switch 100 may send the warning message to a mailbox or a mobile phone of the user of the electronic device 420_1, so as to notify the user that the electronic device 420_1 is currently activated by someone. Moreover, the disabling module 112_3 may also send the warning message to a network management center of the switch 100 to notify a network management personnel that the electronic device 420_1 is currently illegally used by others.

In other embodiments, when the users of the electronic devices 420_1 -420_M are changed to the active status due to login of the entrance guard system 120, the enabling module 112_5 may control the PLC devices 412_1-412_M to correspondingly provide power to the electronic devices 420_1 -420_M, to activate the electronic devices 420_1-420_M or enable the network access authority of the electronic devices 420_1-420_M.

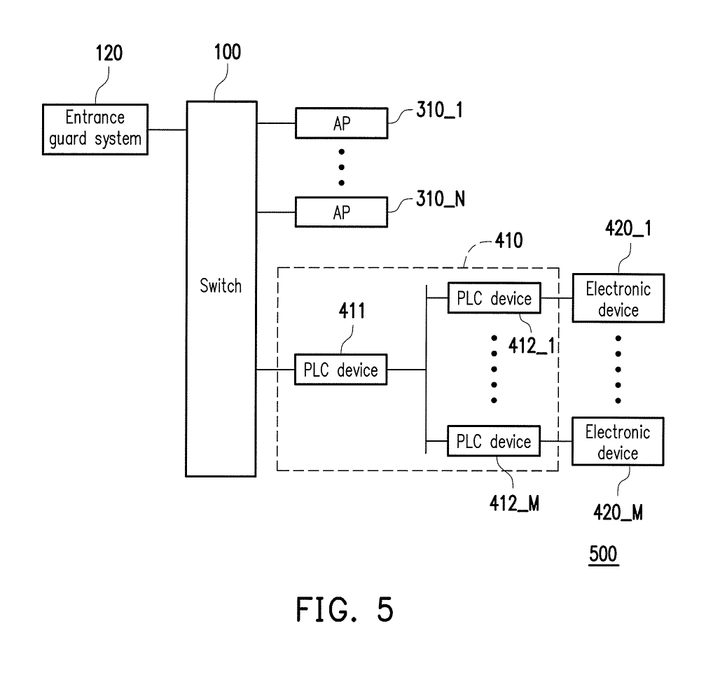

Referring to FIG. 5, FIG. 5 is a system for managing devices based on entrance guard information illustrated according to FIG. 3 and FIG. 4. The system 500 of FIG. 5 can be a combination of the structures of FIG. 3 and FIG. 4, and detailed operation method thereof may refer to the aforementioned descriptions, which are not repeated herein.

In summary, according to the method for managing devices based on entrance guard information and the switch provided by the present embodiment, the electronic devices corresponding to the user can be obtained from the first network management table after the user logs out the entrance guard system. Then, the functions of the electronic devices can be disabled by means of turning off the electronic devices, disabling the network access authority of the electronic devices and/or not to provide power to the electronic devices. In this way, the method and the switch of the invention may decrease the power consumption of the electronic devices, so as to achieve the energy saving effect.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for managing devices based on entrance guard information, comprising:
determining whether a user has logged out an entrance guard system, wherein the entrance guard system is coupled to a switch;
modifying a status corresponding to the user to an inactive status in a first network management table maintained by the switch when the user has logged out the entrance guard system; and
disabling a function of the electronic device corresponding to the user, wherein the user in the first network management table is in the inactive status.

2. The method for managing devices based on entrance guard information as claimed in claim 1, wherein the step of disabling the function of the electronic device corresponding to the user comprises:
turning off the electronic device or disabling a network access authority of the electronic device.

3. The method for managing devices based on entrance guard information as claimed in claim 1, wherein the step of disabling the function of the electronic device corresponding to the user comprises:
controlling a power line communication device to stop providing a power to the electronic device, turn off the electronic device or disable a network access authority of the electronic device, wherein the power line communication device provides the power and the network access authority to the electronic device.

4. The method for managing devices based on entrance guard information as claimed in claim 3, wherein the step of disabling the network access authority of the electronic device comprises:
disabling a medium access control address corresponding to the electronic device in the first network management table.

5. The method for managing devices based on entrance guard information as claimed in claim 1, wherein after the step of disabling the function of the electronic device corresponding to the user in the first network management table, the method further comprises:
sending the first network management table to an access point managed by the switch to update a second network management table maintained by the access point.

6. The method for managing devices based on entrance guard information as claimed in claim 1, wherein when the user does not log out the entrance guard system, the method further comprises:
modifying the status corresponding to the user to an active status in the first network management table, and sending the first network management table to an access point managed by the switch to update a second network management table maintained by the access point.

7. The method for managing devices based on entrance guard information as claimed in claim 6, further comprising:
controlling a power line communication device connected to the electronic device to provide a power to the electronic device.

8. The method for managing devices based on entrance guard information as claimed in claim 6, further comprising:
counting a number of users in the active status in the first network management table; and
determining an operation mode of the access point according to the number of the users.

9. The method for managing devices based on entrance guard information as claimed in claim 1, wherein when the user does not log out the entrance guard system, the method further comprises:
writing a service set identifier and a password corresponding to the service set identifier into an identification card used by the user for logging in the entrance guard system, wherein the service set identifier and the password are used for accessing a wireless network provided by an access point managed by the switch.

10. A switch, coupled to an entrance guard system, comprising:
a memory device, storing a plurality of modules;
a processor, coupled to the memory device, and accessing and executing the modules, and the modules comprising:
a determining module, determining whether a user has logged out the entrance guard system;
a modifying module, modifying a status corresponding to the user to an inactive status in a first network management table maintained by the switch when the user has logged out the entrance guard system; and
a disabling module, disabling a function of an electronic device corresponding to the user, wherein the user in the first network management table is in the inactive status.

11. The switch as claimed in claim 10, wherein the disabling module turns off the electronic device or disables a network access authority of the electronic device.

12. The switch as claimed in claim 10, wherein the disabling module first turns off the electronic device and then disables a network access authority of the electronic device.

13. The switch as claimed in claim 12, wherein when the disabling module detects that the electronic device tries to access a network provided by the switch, the disabling module again turns off the electronic device, or the switch sends a warning message.

14. The switch as claimed in claim 10, wherein the disabling module is configured to control a power line communication device to stop providing a power to the electronic device, turn off the electronic device or disable a network access authority of the electronic device, wherein the power line communication device provides the power and the network access authority to the electronic device.

15. The switch as claimed in claim 10, wherein the disabling module is configured to disable a medium access control address corresponding to the electronic device in the first network management table.

16. The switch as claimed in claim 10, further comprising:
an updating module, configured to send the first network management table to an access point managed by the switch to update a second network management table maintained by the access point.

17. The switch as claimed in claim 10, further comprising:
an updating module, wherein when the user does not log out the entrance guard system, the modifying module is configured to modify the status corresponding to the user to an active status in the first network management table, and the updating module sends the first network management table to an access point managed by the switch to update a second network management table maintained by the access point.

18. The switch as claimed in claim 17, further comprising:
an enabling module, configured to control a power line communication device connected to the electronic device to provide a power to the electronic device.
